(19) United States
(12) Patent Application Publication
(10) Pub. No.: US 2007/0096653 A1
(43) Pub. Date: May 3, 2007

(54) PLASMA DISPLAY PANEL AND METHOD FOR PRODUCING THE SAME

(75) Inventors: Jin Hee JEONG, Gyeonggi-do (KR); Min Soo PARK, Seoul (KR); Bo Hyun KIM, Gyeonggi-do (KR); Byung Gil RYU, Seoul (KR); Deok Hai PARK, Daegu (KR); Young Sung KIM, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/555,488

(22) Filed: Nov. 1, 2006

(30) Foreign Application Priority Data
Nov. 1, 2005 (KR) 10-2005-0103826
Nov. 1, 2005 (KR) 10-2005-0103827
Jan. 23, 2006 (KR) 10-2006-0006829

(51) Int. Cl. H01J 17/49

(52) U.S. Cl. 313/586; 313/582

(57) ABSTRACT

Disclosed is a plasma display panel with improved discharge characteristics. The plasma display panel comprises an upper panel and a lower panel integrally joined to the upper panel through barrier ribs wherein the upper panel includes a dielectric layer, a first protective film formed on one surface of the dielectric layer and composed of magnesium oxide, and a second protective film formed on the first protective film and composed of crystalline magnesium oxide.

This application claims the benefit of Korean Patent Application Nos. 10-2005-0103826, filed on Nov. 01, 2005, 10-2005-0103827, filed on Nov. 1, 2005, 10-2006-0006829, filed on Jan. 23, 2006, which is hereby incorporated by reference as if fully set forth herein.

### BACKGROUND OF THE INVENTION

1. Field of the Invention

The present invention relates to a plasma display panel, and more particularly, to a protective layer of a plasma display panel.

2. Discussion of the Related Art

Plasma display panels comprise an upper panel, a lower panel, and barrier ribs formed between the upper and lower panels to define discharge cells. A major discharge gas, such as neon, helium or a mixed gas thereof, and an inert gas containing a small amount of xenon (Xe) are filled within the discharge cells. When a high-frequency voltage is applied to produce a discharge in the discharge cells, vacuum ultraviolet rays are generated from the inert gas to cause phosphors present between the barrier ribs to emit light, and as a result, images are created. Such plasma display panels have attracted more and more attention as next-generation display devices due to their small thickness and light weight.

FIG. 1 is a perspective view schematically showing the structure of a plasma display panel. As shown in FIG. 1, the plasma display panel comprises an upper panel 100 and a lower panel 110 integrally joined in parallel to and at a certain distance apart from the upper panel. The upper panel 100 includes an upper glass plate 101 as a display plane on which images are displayed and a plurality of sustain electrode pairs, each of which consists of a scan electrode 102 and a sustain electrode 103, arranged on the upper glass plate 101. The lower panel 110 includes a lower glass plate 111 and a plurality of address electrodes 113 arranged on the lower glass plate 111 so as to cross the plurality of sustain electrode pairs.

Stripe type (or well type, etc.) barrier ribs 112 for forming a plurality of discharge spaces, i.e. discharge cells, are arranged parallel to each other on the lower panel 110. A plurality of address electrodes 113, which act to perform an address discharge, are disposed in parallel with respect to the barrier ribs to generate vacuum ultraviolet rays. Red (R), green (G) and blue (B) phosphors 114 are applied to upper sides of the lower panel 110 to emit visible rays upon address discharge, and as a result, images are displayed. A lower dielectric layer 115 is formed between the address electrodes 113 and the phosphors 114 to protect the address electrodes 113.

An upper dielectric layer 104 is formed on the sustain electrode pairs 103, and a protective layer 105 is formed on the upper dielectric layer 104. The upper dielectric layer 104, which is included in the upper panel 100, is worn out due to the bombardment of positive (+) ions upon discharge of the plasma display panel. At this time, short circuiting of the electrodes may be caused by metal elements, such as sodium (Na). Thus, a magnesium oxide (MgO) thin film as the protective layer 105 is formed by coating to protect the upper dielectric layer 104. Magnesium oxide sufficiently withstands the bombardment of positive (+) ions and has a high secondary electron emission coefficient, thus achieving a low firing voltage.

However, the protective layer of the conventional plasma display panel has the following problems.

Firstly, since the magnesium oxide crystal particles constituting the protective layer have a non-uniform diameter, the density of the protective layer is lowered and the crystal is not sufficiently grown.

Secondly, since the magnesium oxide crystal particles constituting the protective layer have a non-uniform size, impurities, e.g., moisture and impurity gases, are attached to the surface of the protective layer. These impurities impede the discharge of the plasma display panel, and cause low contrast and high firing voltage of the plasma display panel, making the circuit structure complicated. This complicated circuit structure may incur considerable costs. Furthermore, the deterioration of the characteristics of the protective layer is intimately associated with the deterioration of jitter characteristics.

Thirdly, although a highly sputtering-resistant protective layer can be formed by improving the alignment and crystallinity of magnesium oxide and increasing the density of the protective layer, a protective layer formed by e-beam deposition emits a small number of secondary electrons, and hence, the power consumption of a plasma display panel comprising the protective layer still remains high.

### SUMMARY OF THE INVENTION

Accordingly, the present invention is directed to a plasma display panel and a method for producing the plasma display panel that substantially obviate one or more problems due to limitations and disadvantages of the related art.

An object of the present invention is to provide a protective layer of a plasma display panel wherein the protective layer is composed of magnesium oxide crystal particles having a uniform size.

Another object of the present invention is to provide a protective layer that lowers the firing voltage of a plasma display panel comprising the protective layer and that improves the contrast and jitter characteristics of the plasma display panel.

A further object of the present invention is to provide a plasma display panel with improved brightness and reduced power consumption in which a protective layer emits an increased number of secondary electrons.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel comprises an upper panel and a lower panel integrally joined to the upper panel through barrier ribs wherein the upper panel includes a dielectric layer, a first protective film formed on one surface of the dielectric layer and composed of magnesium oxide, and a second protective film formed on the first protective film and composed of crystalline magnesium oxide.

In another aspect of the present invention, there is provided a method for preparing a liquid of magnesium oxide which comprises pre-mixing a solvent and a dispersant, milling a single-crystal magnesium oxide powder, mixing the milled single-crystal magnesium oxide powder with the pre-mixture of the solvent and dispersant, and drying and calcining the mixture.

In yet another aspect of the present invention, there is provided a method for producing a plasma display panel which comprises forming a first protective film composed of magnesium oxide on one surface of a dielectric layer of an upper panel, and applying a liquid of single-crystal magnesium oxide to the first protective film, followed by drying and calcining.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a conventional plasma display panel;

FIG. 2 is a cross-sectional view of a protective layer of a plasma display panel according to a first embodiment of the present invention;

FIG. 3 is a cross-sectional view of a plasma display panel according to a second embodiment of the present invention;

FIG. 4 is a cross-sectional view of a protective layer of a plasma display panel according to a third embodiment of the present invention;

FIG. 5 is a flow chart illustrating a method for preparing a liquid of magnesium oxide according to an embodiment of the present invention;

FIG. 6 is a flow chart illustrating a method for producing a plasma display panel according to an embodiment of the present invention;

FIGS. 7A and 7B are graphs showing changes in discharge current and brightness of plasma display panels, respectively, each of which comprises a protective layer formed using a liquid of magnesium oxide; and

FIG. 8 is a graph showing changes in the discharge current of a plasma display panel, which comprises a bilayered protective layer, according to an embodiment of the present invention.

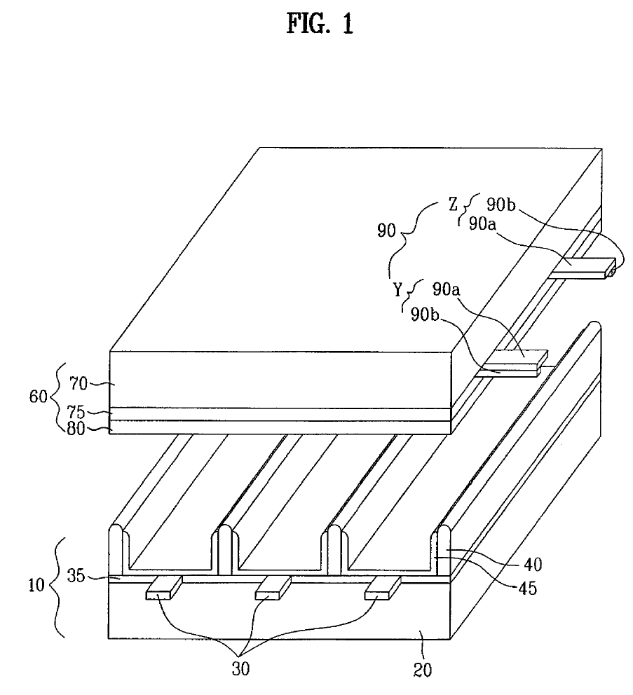

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention provides a plasma display panel comprising a bilayered protective layer. Hereinafter, a layer formed on one surface of an upper dielectric layer is referred to as a ‘first protective film’, and a layer formed on the first protective film is referred to as a ‘second protective film’.

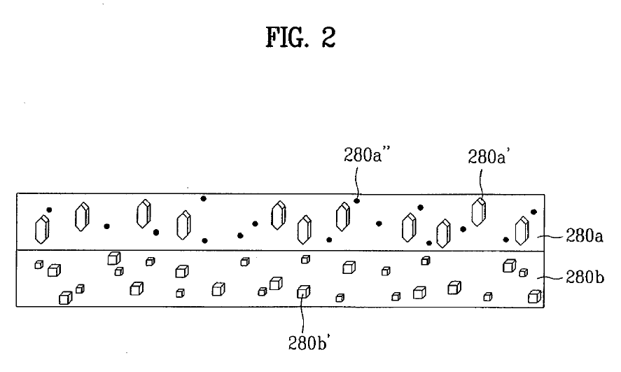

FIG. 2 is a cross-sectional view of a protective layer of a plasma display panel according to a first embodiment of the present invention. With reference to FIG. 2, a detailed explanation of the protective layer of the plasma display panel according to the first embodiment of the present invention will be provided below.

The protective layer of the plasma display panel according to the first embodiment of the present invention comprises a first protective film 280a formed on one surface of an upper dielectric layer and a second protective film 280b formed on the first protective film. Both first and second protective films 280a and 280b are composed of magnesium oxide (MgO). Specifically, magnesium oxide is coated to form thin films to protect the upper dielectric layer upon plasma discharge, so that the service life of the plasma display panel is guaranteed. When plasma ions are incident on the first and second protective films, secondary electrons are emitted from the surfaces of the first and second protective films 280a and 280b. This emission of secondary electrons allows the discharge to be produced at a lower voltage, leading to a reduction in power consumption.

Magnesium oxide particles for the protective layer of the plasma display panel according to the first embodiment of the present invention must have a uniform diameter, a low porosity and a high density so that they can prevent attachment of impurity gases to the surface of the protective layer to lower the firing voltage of the plasma display panel. These characteristics of the protective layer will be particularly determined by the composition of the second protective film 280b that is in direct contact with a plasma gas. The protective layer of the plasma display panel according to the first embodiment of the present invention preferably consists of a first protective film 280a, which has similar characteristics to conventional protective films, and a second protective film 280b, which has characteristics suitable for achieving the objects of the present invention. In the first embodiment, the second protective film 280b has a thickness of about 50 to about 200 μm, and the first protective film 280a has a thickness of about 300 to about 750 μm.

The electrical properties of the protective layer are determined by the second protective film 280b that is in contact with a plasma gas, and those of the protective film 280b are determined by the characteristics of the surface that is in contact with a plasma gas. As the time of use of the plasma display panel increases, the magnesium oxide present on the surface of the protective layer may be sputtered and adsorbed to other surfaces. From the viewpoint of the service life of the plasma display panel, the thickness of the first protective film must be adjusted to have a thickness of 50 μm or more and preferably 200 μm. If the protective layer of the plasma display panel is formed by a method other than conventional methods, it is expected to suffer from disadvantages, e.g., difficult processing and increased costs. Based on these disadvantages, according to the first embodiment, the two protective films (e.g., the first and second protective films 280a and 280b are used to form the protective layer and the second protective film 280b, which directly affects the discharge characteristics of the protective layer, has a different composition from conventional protective films.

That is, the composition of the first protective film 280a, which is similar to that of a conventional protective film, comprises at least one material selected from single-crystal magnesium oxide and polycrystalline magnesium oxide. Alternatively, the first protective film may be formed by sputtering such that it has substantially no crystallinity. On the other hand, the second protective film 280b is composed of a material prepared using a magnesium oxide powder. Accordingly, the magnesium oxide present in the second protective film 280b is highly crystalline and is relatively large in size, compared to that present in the first protective film 280a. The magnesium oxide used to form the second protective film 280b may be polycrystalline or single-crystal magnesium oxide.

The magnesium oxide particles used to form the second protective film 280b are prepared by pulverizing single-crystal or polycrystalline magnesium oxide, shaping the powder using a press, and sintering the shaped powder. Details for the preparation of the magnesium oxide particles will be described below. As shown in FIG. 2, the magnesium oxide particles 280b′ constituting the second protective film 280b preferably have a uniform size, a low porosity and a high density as compared to the particles 280a′ constituting the first protective film 280a, so that they can prevent attachment of impurity gases to the surface of the protective layer to lower the firing voltage of the plasma display panel. That is, the magnesium oxide crystal particles are pulverized under specified conditions to control the diameter of the particles, pressurized to shape the powder, and sintered at a high temperature, so that the diameter and density of the crystal particles can be adjusted to optimal levels while maintaining the inherent characteristics of the crystal particles. Since the porosity of the magnesium oxide crystal particles is lowered but the density of the crystal particles increases with decreasing diameter of the crystal particles, difficult processing and an increase in costs are expected. Thus, the magnesium oxide crystal particles preferably have a diameter of 10 μm or less.

At least one element selected from aluminum (Al) boron (B), barium (Ba), silicon (Si), lead (Pb), phosphorus (P), gallium (Ga), germanium (Ge), scandium (Sc) and yttrium (Y) is preferably added to form the first protective film 280a to lower the porosity and increase the density of the first protective film. As a result, attachment of impurity gases to the surface of the MgO thin film is prevented to lower the firing voltage of the plasma display panel. The element is designated by numeral 280a″ in FIG. 2. The concentration of at least one element selected from Al, B, Ba, Si, Pb, P, Ga, Ge, Sc and Y in the first protective film 280a is preferably limited to 5,000 ppm (parts per million) or less and more preferably between 300 and 500 ppm. The amount of silicon added may be limited to a predetermined concentration to control the electrical properties, such as secondary electron emission coefficient and film resistance, of the protective layer of the plasma display panel. Consequently, the firing voltage of the plasma display panel comprising the protective layer with the above characteristics can be lowered and single scanning of the plasma display panel is enabled, resulting in a reduction in the production costs of driving circuits. It is preferred that an oxide powder of the element be homogeneously mixed with the magnesium oxide crystal particles within the first protective film 280a. Examples of suitable oxides include Al₂O₃, B₂O₃, SiO₂, P₂O₅, Ga₂O₃, GeO₂, Sc₂O₃, and Y₂O₃. For example, Al₂O₃ is pulverized and mixed with a powder of the magnesium oxide crystal particles, the mixed powder is shaped using a press, and the shaped powder is sintered to form the first protective film 280a.

The second protective film 280b is formed under the first protective film 280a by deposition. The deposition is achieved by liquid-phase deposition, sputtering, ion plating, e-beam deposition or vapor phase oxidation. Examples of suitable liquid-phase deposition processes includes sol-gel deposition and emulsion deposition. According to sol-gel deposition, the second protective film 280b may be formed by hydrolysis-condensation of a metal alkoxide represented by M(OR)ₙ (wherein M is a metal or a semi-metal selected from Cu, Al, Si, Ti, Ge, V, W, Y, Sn, In and Sb, and R is a methyl, ethyl, propyl or butyl group) at a low temperature. Sputtering is a process utilizing a sputtering phenomenon and is widely employed at present to form various thin films. According to a sputtering process, particles having a high energy (>30 eV) collide with a target to transfer the energy to the target atoms, after which the target atoms are emitted from the target to form the second protective film 280b. Cathodic sputtering wherein the collided particles are positive ions is most widely employed. The reason why positive ions are generally used for the sputtering is that when an electric field is applied, positive ions are readily accelerated and are neutralized by electrons emitted from a target just before collision with the target, after which the neutral atoms collide with the target. Ion plating is a general name for combinations of vacuum evaporation and sputtering. According to ion plating, glow discharge is produced when a high voltage is applied under a high vacuum to form a plasma and parts of vaporized atoms are ionized. These phenomena are utilized to form the second protective film 280b. According to e-beam deposition, the second protective film 280b is formed by heating magnesium oxide crystal particles to a high temperature, i.e. by using physical energy. According to vapor phase oxidation, a magnesium vapor is used to heat polycrystalline magnesium oxide.

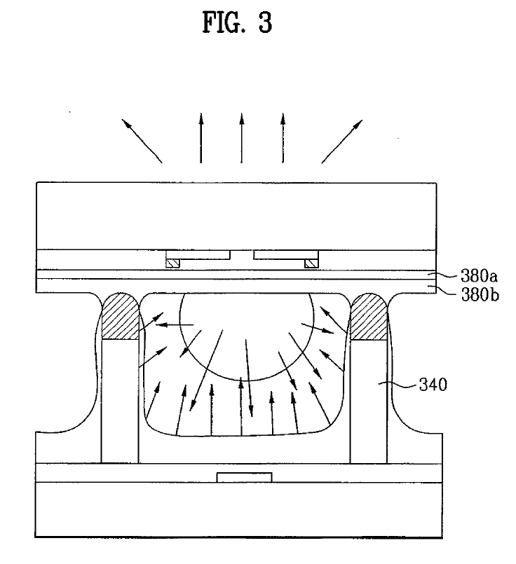

FIG. 3 is a cross-sectional view of a plasma display panel according to a second embodiment of the present invention. With reference to FIG. 3, an explanation of the plasma display panel according to the second embodiment of the present invention will be provided below.

According to the second embodiment, the thickness of portions of a second protective film 380b that are in contact with barrier ribs 340 is larger than that of the other portions of the second protective film 380b. Specifically, since ions of a plasma gas are frequently brought into contact with the second protective film 380b that is in contact with the barrier ribs 340 upon discharge of the plasma display panel, the contact portions between the second protective film 380b and the barrier ribs are formed to have a larger thickness than the other portions. Like the protective layer of the plasma display panel according to the first embodiment, the protective layer of the plasma display panel according to the second embodiment consists of two protective films 380a and 380b. The first protective film 380a has a uniform thickness, while the second protective film 380b has a non-uniform thickness.

The plasma display panel according to the second embodiment of the present invention has the same structure as the plasma display panel according to the first embodiment, except that the structure of the protective layer is varied. That is, the second protective film 380b is composed of magnesium oxide particles having a relatively uniform diameter, while the first protective film 380a is composed of magnesium oxide particles having a relatively non-uniform diameter. The first protective film 380a is composed of at least one material selected from single-crystal magnesium oxide and polycrystalline magnesium oxide, and the second protective film 380b is preferably composed of a material prepared using a magnesium oxide powder. The thickness of portions of the second protective film 380b that are not in contact with barrier ribs 340 is preferably in the range of 1 nm to 200 nm. The second protective film 380b may contain at least one element selected from Al, B, Ba, Si, Pb, P, Ga, Ge, Sc and Y. The element is preferably added in the form of an oxide. In addition, the element is preferably used at a concentration not higher than 5,000 ppm and preferably a concentration of 300 to 500 nm. In addition, the second protective film 380b is preferably formed by a deposition process selected from liquid-phase deposition, sputtering, ion plating, e-beam deposition, and vapor phase oxidation.

The smaller the diameter of the particles constituting the protective layer, the lower the binding energy between the particles. Accordingly, when a driving voltage is applied to the plasma display panel comprising the protective layer, the particles are sublimed with high energy. That is, the energy of the particles constituting the protective layer is increased with decreasing average diameter of the particles. As a result, the growth of a crystal is promoted, so that attachment of impurities (e.g., moisture and impurity gases) to the surface of the protective film is prevented and obstacles to the discharge of the plasma display panel are reduced, resulting in a decrease in firing voltage and an increase in contrast.

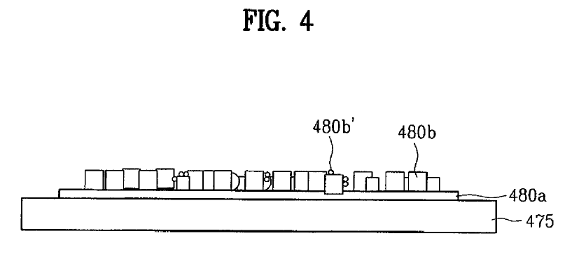

FIG. 4 is a cross-sectional view of a protective layer of a plasma display panel according to a third embodiment of the present invention. With reference to FIG. 4, an explanation of the plasma display panel according to the third embodiment of the present invention will be provided below.

Like the protective layer of the plasma display panel according to the second embodiment, the protective layer of the plasma display panel according to the third embodiment is formed by forming a first protective film 480a on one surface of an upper dielectric layer 475 and forming a second protective film 480b on the first protective film 480a. It is preferred that the second protective film 480b be composed of single-crystal magnesium oxide particles having a size of 100 to 500 nm. It is preferred that the first protective film 480a have a thickness of 500 to 800 nm and the second protective film 480b have a thickness of 100 to 1,500 nm. The first protective film 480a is preferably formed by e-beam deposition of magnesium oxide, and the second protective film 480b is formed by applying a liquid of single-crystal magnesium oxide to the first protective film 480a, followed by drying and calcining. The second protective film 480b may contain small-sized magnesium oxide crystal particles. The small-sized magnesium oxide crystal particles are formed by milling during the preparation of a liquid of magnesium oxide, which will be explained below. The second protective film 480b is preferably formed over the entire surface of the first protective film 480a. The second protective film 480b acts to prevent the first protective film 480a from being sputtered so that the service life of the protective layer can be increased and the secondary electron emission characteristics can be improved.

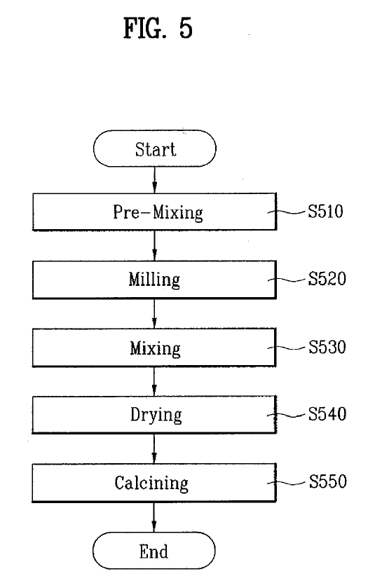

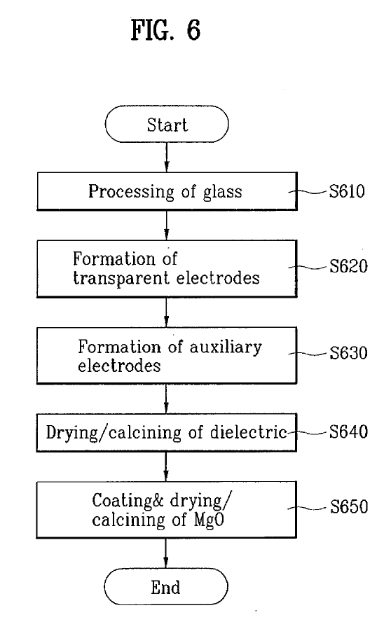

FIG. 5 is a flow chart illustrating a method for preparing a liquid of magnesium oxide according to an embodiment of the present invention, and FIG. 6 is a flow chart illustrating a method for producing a plasma display panel according to an embodiment of the present invention. With reference to FIGS. 5 and 6, an explanation of the method for producing a plasma display panel according to the embodiment of the present invention will be provided below.

Sustain electrode pairs and a dielectric layer are sequentially formed on an upper glass plate (S610 to S640), and then a protective layer is formed on the dielectric layer (S650). The formation of the protective layer is largely divided into the following two steps. First, a first protective film is preferably formed on the dielectric layer by deposition (e.g., e-beam deposition) of magnesium oxide. Subsequently, a second protective film is formed on the first protective film by the following procedure.

The formation of the second protective film on the first protective film is achieved by the use of a liquid of a single-crystal magnesium oxide powder. First, a solvent and a dispersant are pre-mixed to prepare a primary solution (S510). As the solvent, preferred is at least one solvent selected from alcohols, such as methanol and ethanol, glycols, propylene glycol ethers, propylene glycol acetates, ketones, BCA, xylene, terpineol, texanol, and water. As the dispersant, preferred is a polymeric dispersant selected from acrylic resins, epoxy resins, urethane resins, acrylic urethane resins, alkyd resins, polyamid polymers, and polycarboxylic acids. The pre-mixing is preferably carried out at 2,000-4,000 rpm for 1-10 minutes.

Subsequently, a single-crystal magnesium oxide powder is milled (S520) to a uniform size. The milling is preferably carried out at 6,000-10,000 rpm for 10-60 minutes. At this time, small-sized single-crystal MgO particles (480b′ in FIG. 4) may be formed. The milled single-crystal MgO powder and the primary solution are mixed together (S530), dried, and calcined to prepare a liquid. By the mixing, the dispersant and the single-crystal magnesium oxide powder are homogeneously mixed. At least one additive selected from organic and inorganic binders and leveling agents is added during the mixing. At this time, the single-crystal magnesium oxide powder is used in an amount of 1 to 30% by weight, based on the total weight of the liquid. The dispersant is used in an amount of 5 to 60% by weight, based on the weight of the single-crystal magnesium oxide powder.

Then, the liquid is dried at about 100° C. to about 200° C. (S540) and calcined at 400° C. to 600° C. (S550) to substantially evaporate the solvent and the dispersant, leaving the single-crystal magnesium oxide powder behind. The liquid thus prepared is coated on the first protective film, dried, calcined, and annealed to form a second protective film. The annealing is preferably carried out at 300-500° C. to evaporate the organic materials. The liquid is preferably coated on the first protective film by a coating technique selected from dipping, die coating, spin coating, spray coating, and ink-jet coating. The magnesium oxide crystal particles constituting the second protective film have a larger size than those constituting the first protective film. The second protective film is preferably formed over the entire surface of the first protective film.

In an alternative embodiment of the present invention, a single-crystal magnesium oxide powder may be formed into a green sheet. Specifically, the second protective film is preferably formed by laminating the green sheet containing the single-crystal magnesium oxide powder on the first protective film. A smaller amount of a solvent must be present in the green sheet than in the liquid. It is to be appreciated that a polycrystalline magnesium oxide powder can be used instead of the single-crystal magnesium oxide powder.

When a sealing material is applied to an upper plate to produce a plasma display panel, which comprises the protective layer, according to the present invention, coating of a liquid or a paste for the protective layer on the upper plate may be difficult. Alternatively, when a liquid or a paste is coat on an upper plate before application of a sealing material to the upper plate, components of the sealing material may be evaporated to cause chemical reactions with the liquid or paste. Accordingly, it is preferred to integrally join a lower plate to an upper plate after a sealing material is applied to the lower plate.

The present invention also provides a plasma display panel which comprises an upper panel including sustain electrode pairs, an upper dielectric layer and a protective layer sequentially formed on an upper substrate, and a lower plate including address electrodes, a lower dielectric layer and barrier ribs sequentially formed on a lower substrate wherein the protective layer consists of a first protective film formed on one surface of the upper dielectric layer and composed of magnesium oxide, and a second protective film formed on the first protective film and composed of a magnesium oxide powder. Preferably, a sealing material is applied to the lower plate and then the upper plate is integrally joined to the lower plate. The magnesium oxide powder is preferably prepared by applying the liquid of magnesium oxide to the first protective film, and drying, calcining and annealing the liquid.

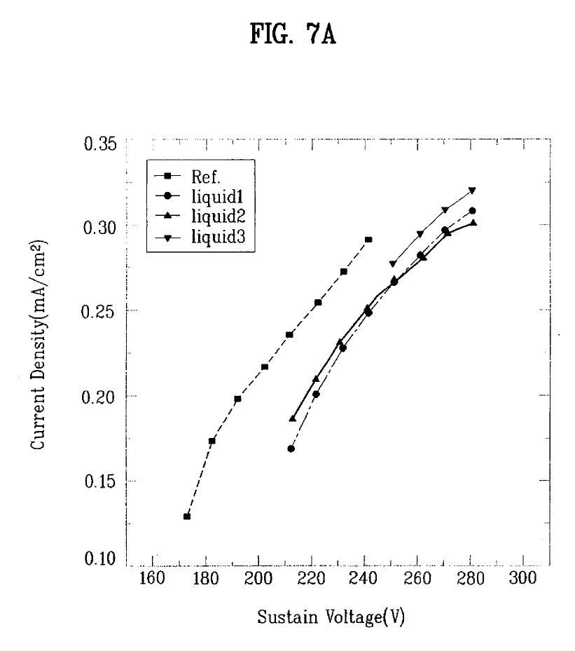

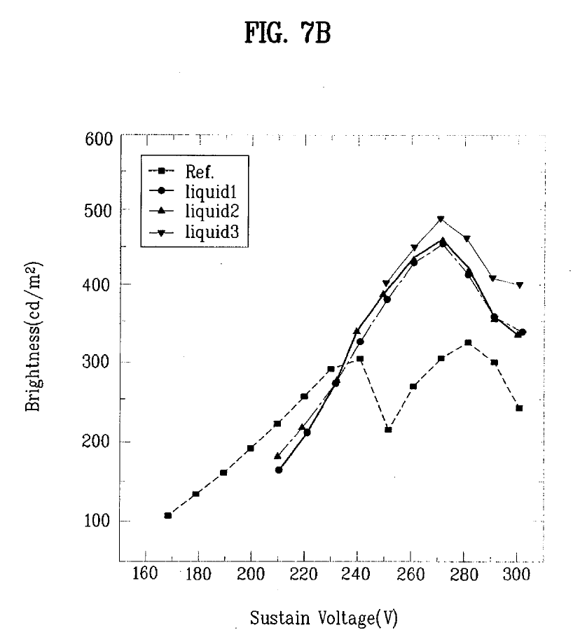

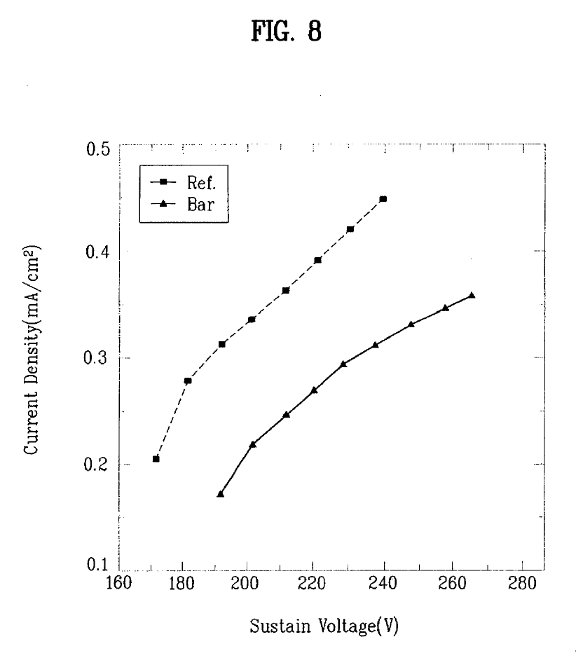

FIGS. 7A and 7B are graphs showing changes in discharge current and brightness of plasma display panels, respectively, each of which comprises a protective layer formed using the liquid of magnesium oxide. FIG. 8 is a graph showing changes in the discharge current of a plasma display panel, which comprises a bilayered protective layer, according to an embodiment of the present invention.

The graphs of FIGS. 7A and 7B indicate that the plasma display panels according to the three embodiments, in which the protective layers are formed using the liquid of magnesium oxide, show a low discharge current and a high brightness as compared to conventional plasma display panels. The graph of FIG. 8 indicates that when e-beam deposition is employed to form the first protective film and liquid-phase deposition is employed to form the second protective film on the first protective film, the plasma display panel shows a low discharge current. That is, the magnesium oxide constituting the second protective film, which is formed by coating of the liquid of the magnesium oxide, is in the form of a powder having a larger crystal size than that constituting the first protective film. These results demonstrate that increased cross-sectional area of the bilayered protective layer leads to an increase in the number of secondary electrons emitted, ultraviolet (UV) rays are reflected from the single-crystal magnesium oxide powder, resulting in an increase in the amount of visible rays emitted from phosphors, and the first protective film serves to protect the upper dielectric layer, which is an inherent characteristic of the protective layer.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising an upper panel and a lower panel integrally joined to the upper panel through barrier ribs wherein the upper panel includes a dielectric layer, a first protective film formed on one surface of the dielectric layer and composed of magnesium oxide, and a second protective film formed on the first protective film and composed of crystalline magnesium oxide.

2. The plasma display panel according to claim 1, wherein the first protective film is formed by sputtering of the magnesium oxide.

3. The plasma display panel according to claim 1, wherein the crystalline magnesium oxide particles constituting the second protective film have a more uniform size than the magnesium oxide particles constituting the first protective film.

4. The plasma display panel according to claim 1, wherein the first protective film is composed of at least one material selected from single-crystal magnesium oxide and polycrystalline magnesium oxide, and the second protective film is composed of a material prepared using a single-crystal magnesium oxide powder.

5. The plasma display panel according to claim 1, wherein the first protective film is composed of at least one material selected from single-crystal magnesium oxide and polycrystalline magnesium oxide, and the second protective film is composed of a material prepared using a polycrystalline magnesium oxide powder.

6. The plasma display panel according to claim 1, wherein the crystalline magnesium oxide particles have a diameter of 10 μm or less.

7. The plasma display panel according to claim 1, wherein the second protective film has a smaller thickness than the first protective film.

8. The plasma display panel according to claim 1, wherein the first protective film contains at least one element selected from aluminum (Al), boron (B), barium (Ba), silicon (Si), lead (Pb), phosphorus (P), gallium (Ga), germanium (Ge), scandium (Sc), and yttrium (Y).

9. The plasma display panel according to claim 8, wherein the at least one element selected from Al, B, Ba, Si, Pb, P, Ga, Ge, Sc and Y is present at a concentration of 500 ppm in the first protective film.

10. The plasma display panel according to claim 1, wherein the second protective film is formed by a deposition process selected from liquid-phase deposition, sputtering, ion plating, sol-gel deposition, e-beam deposition, and vapor phase oxidation.

11. The plasma display panel according to claim 1, wherein the second protective film has portions that are in contact with the barrier ribs, and the thickness of the portions is larger than that of the other portions.

12. A method for preparing a liquid of magnesium oxide, the method comprising
pre-mixing a solvent and a dispersant,
milling a single-crystal magnesium oxide powder,
mixing the milled single-crystal magnesium oxide powder with the pre-mixture of the solvent and dispersant, and
drying and calcining the mixture.

13. The method according to claim 12, wherein the solvent is selected from alcohols, glycols, propylene glycol ethers, propylene glycol acetates, ketones, BCA, xylene, terpineol, texanol, water, and mixtures thereof.

14. The method according to claim 12, wherein the dispersant is selected from acrylic resins, epoxy resins, urethane resins, acrylic urethane resins, alkyd resins, polyamid polymers, polycarboxylic acids, and mixtures thereof.

15. The method according to claim 12, wherein the pre-mixing is carried out at 2,000-4,000 rpm for 1-10 minutes.

16. The method according to claim 12, wherein the milling is carried out at 6,000-10,000 rpm for 10-60 minutes.

17. The method according to claim 12, wherein the single-crystal magnesium oxide powder is used in an amount of 1 to 30% by weight, based on the total weight of the liquid.

18. The method according to claim 17, wherein the dispersant is used in an amount of 5 to 60% by weight, based on the weight of the single-crystal magnesium oxide powder.

19. A method for producing a plasma display panel, the method comprising
forming a first protective film composed of magnesium oxide on one surface of a dielectric layer of an upper panel,
and applying a liquid of single-crystal magnesium oxide to the first protective film, followed by drying and calcining.

20. The method according to claim 19, further comprising annealing the liquid of single-crystal magnesium oxide.

21. The method according to claim 20, wherein the annealing is carried out at 300-500° C.

22. The method according to claim 19, wherein the single-crystal magnesium oxide particles have a size of 100 to 500 nm.

23. The method according to claim 19, wherein the first protective film has a thickness of 500 to 800 nm.

24. The method according to claim 19, wherein the second protective film has a thickness of 100 to 1,500 nm.

25. The method according to claim 19, wherein the liquid contains 1 to 30% by weight of a single-crystal magnesium oxide powder, based on the total weight of the liquid.

26. The method according to claim 19, wherein the liquid contains 5 to 60% by weight of a dispersant, based on the weight of the single-crystal magnesium oxide powder.

27. The method according to claim 19, wherein the application of the liquid is carried out by a coating technique selected from dipping, die coating, spin coating, spray coating, and ink-jet coating.

28. A method for producing a plasma display panel, the method comprising
forming a first protective film composed of magnesium oxide on one surface of a dielectric layer of an upper panel, and
forming a green sheet of a single-crystal magnesium oxide powder on the first protective film.
